(19) United States
(12) Patent Application Publication
(10) Pub. No.: US 2008/0158392 A1
(43) Pub. Date: Jul. 3, 2008

(54) IMAGING APPARATUS AND DISPLAYING METHOD FOR IMAGING APPARATUS

(76) Inventor: Kenji Nikata, Kanagawa (JP)

Correspondence Address: David R. Metzger;SONNENSCHEIN NATH & ROSENTHAL LLP, Sears Tower, Wacker Drive Station, Post Office Box 061080, Chicago, IL, 60606-1080, US

(21) Appl. No.: 11/615,205

(22) Filed: Dec. 22, 2006

(30) Foreign Application Priority Data
Dec. 27, 2005 (JP) P2005-373823

(51) Int. Cl. H04N 9/68; H04N 5/222

(52) U.S. Cl. 348/234; 348/333.02; 345/77; 348/E09.053; 348/E05.022

(57) ABSTRACT

An imaging apparatus that displays a monitoring image of an imaging result acquired by an imaging unit on a monitor and also displays information on the apparatus on the monitor in the form of an on-screen display on the monitoring image, the apparatus including a brightness level detection unit that detects the brightness level of the imaging result and outputs the brightness level detection result and a display control unit that controls the brightness level of the on-screen display according to the brightness level detection result to lower the brightness level of the displayed information on the apparatus in response to decrease in brightness level of the imaging result.

### CROSS REFERENCES TO RELATED APPLICATIONS

The present invention contains subject matter related to Japanese Patent Application JP2005-373823 filed in the Japanese Patent Office on Dec. 27, 2005, the entire contents of which being incorporated herein by reference.

### BACKGROUND OF THE INVENTION

1. Field of the Invention

The present invention relates to an imaging apparatus and a displaying method for the imaging apparatus, which can be applied to, for example, a video camcorder. The present invention can prevent reduced visibility due to an on-screen display when a dark subject is imaged and displayed by lowering the brightness level of the on-screen display in response to decrease in brightness level of a monitoring image.

2. Description of the Related Art

An imaging apparatus, such as a video camcorder, of related art has a monitor, such as a liquid crystal display panel, for displaying an imaging result to allow the user to image a desired subject while monitoring the imaging result. The monitor also displays on-screen display information, such as the remaining recordable time of a recording medium, so that the user can monitor imaging related conditions while monitoring the imaging result on the monitor.

In an imaging apparatus of related art, such as on-screen display is set to a fixed brightness level. On the other hand, an important warning, such as the one indicating that no recording medium is loaded, is displayed by a blinking on-screen display to reliably notify the user of the on-screen display information.

Regarding such an on-screen display, JP-A-2002-314852 proposes a method for improving visibility of an on-screen display by setting the color of the on-screen display to be different from that of the background for enhancement.

An imaging apparatus of this type may image a dark subject. In this case, an imaging apparatus of related art sets the on-screen display to a fixed brightness level, so that the on-screen display is relatively brighter than the background, resulting in increased visibility of the on-screen display.

However, in terms of the displayed imaging result, the inherently dark displayed subject becomes further less visible due to the bright on-screen display, undesirably resulting in reduced visibility. In this case, some of monitors may prevent the user from checking details of the subject. Furthermore, when imaging a dark subject in a dark environment, the user may be annoyed by glare from the on-screen display. Particularly in recent years, an imaging apparatus tends to display more pieces of on-screen display information, so that the region for the on-screen display increases accordingly, resulting in significantly reduced visibility of such a dark subject.

### SUMMARY OF THE INVENTION

The invention has been made in view of the above circumstances and it is desirable to provide an imaging apparatus and a displaying method for the imaging apparatus capable of preventing reduced visibility due to an on-screen display when a dark subject is imaged and displayed.

According to a first embodiment of the invention, there is provided an imaging apparatus that displays a monitoring image of an imaging result acquired by an imaging unit on a monitor and also displays information on the apparatus on the monitor in the form of an on-screen display on the monitoring image. The apparatus includes a brightness level detection unit that detects the brightness level of the imaging result and outputs the brightness level detection result, and a display control unit that controls the on-screen display according to the brightness level detection result to lower the brightness level of the displayed information on the apparatus in response to decrease in brightness level of the imaging result.

According to a second embodiment of the invention, there is provided a displaying method for an imaging apparatus that displays a monitoring image of an imaging result acquired by an imaging unit on a monitor and also displays information on the apparatus on the monitor in the form of an on-screen display on the monitoring image. The method includes the steps of detecting the brightness level of the imaging result and outputting the brightness level detection result, and controlling the on-screen display according to the brightness level detection result to lower the brightness level of the displayed information on the apparatus in response to decrease in brightness level of the imaging result.

According to the configuration of the imaging apparatus of the first embodiment of the invention, since the apparatus that displays a monitoring image of an imaging result acquired by an imaging unit on a monitor and also displays information on the apparatus on the monitor in the form of an on-screen display on the monitoring image includes a brightness level detection unit that detects the brightness level of the imaging result and outputs the brightness level detection result, and a display control unit that controls the on-screen display according to the brightness level detection result to lower the brightness level of the displayed information on the apparatus in response to decrease in brightness level of the imaging result, when a dark subject is imaged and displayed, the apparatus can lower the brightness level of the on-screen display such that the displayed subject is not affected, thereby preventing reduced visibility due to the on-screen display when a dark subject is imaged and displayed.

According to the configuration of the second embodiment of the invention, there is provided a displaying method for an imaging apparatus capable of preventing reduced visibility due to an on-screen display when a dark subject is imaged and displayed.

The invention can prevent reduced visibility due to an on-screen display when a dark subject is imaged and displayed.

### BRIEF DESCRIPTION OF THE DRAWINGS

FIG. 1 is a block diagram showing the video camcorder according to an embodiment of the invention;

FIG. 2 is a plan view used for explaining an on-screen display on the display of the video camcorder shown in FIG. 1;

FIG. 3 a flowchart showing a process procedure of the control unit of the video camcorder shown in FIG. 1;

FIG. 4 is a schematic diagram used for explaining the process procedure shown in FIG. 3;

FIG. 5 is a flowchart showing a brightness level determining/setting process for each drawing region in the process shown in FIG. 3;

FIG. 6 is a characteristic curve used for explaining how to set the brightness level in the process shown in FIG. 5; and

FIG. 7 is a functional block diagram of the control unit responsible for the processes shown in FIGS. 3 and 5.

### DESCRIPTION OF THE PREFERRED EMBODIMENTS

Embodiments of the invention will be described below in detail with reference to the drawings as appropriate.

### First Embodiment

### (1) Configuration of the Embodiment

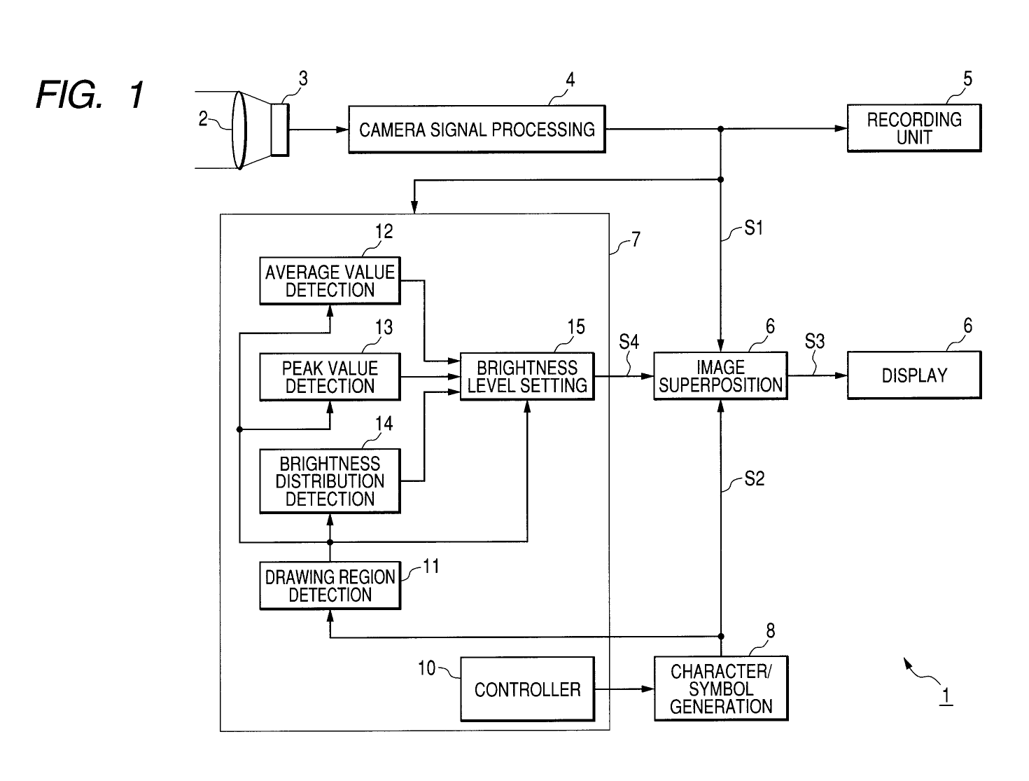

FIG. 1 is a block diagram showing the configuration of the video camcorder according to the embodiment of the invention. The video camcorder 1 has a battery-powered mobile configuration. In the video camcorder 1, a lens 2 focuses incident light and forms an optical image of a subject on the imaging plane of an imaging element 3. The zoom magnification and aperture size are variable in response to user operations.

The imaging element 3 photoelectrically processes the optical image of the subject formed on the imaging plane and outputs the imaging result. A camera signal processing circuit 4 performs gamma correction, noise reduction and other processing on the output signal from the imaging element 3 and outputs a video signal S1 formed of a brightness signal and a color difference signal.

A recording unit 5 performs data compression on the video signal S1 outputted from the camera signal processing circuit 4 and records a movie file or a still image file derived from the imaging result on a recording medium under the control of a control unit 7. In this way, the video camcorder 1 records the imaging result in the form of a movie or a still image. In this embodiment, although a magnetic tape and a memory card are used as the recording medium for the recording unit 5, the magnetic tape and/or the memory card as the recording medium may be replaced with a wide variety of recording media, such as an optical disk and a magnetic disk.

Under the control of the control unit 7, an image superimposing circuit 6 combines the video signal S1 outputted from the camera signal processing circuit 4 with an on-screen display video signal S2 outputted from a character/symbol generation circuit 8 to create a video signal S3 and outputs the video signal S3 to a display 9.

The display 9 is a monitor formed of a liquid crystal display panel or the like and displays an image based on the video signal outputted from the image superimposing circuit 6.

In this way, the video camcorder 1 displays a monitoring image of the imaging result obtained from the imaging system on the display 9. In this process, the image superimposing circuit 6 combines the monitoring image with the on-screen display video signal S2, so that various kinds of information are notified to the user through the on-screen display on the monitoring image.

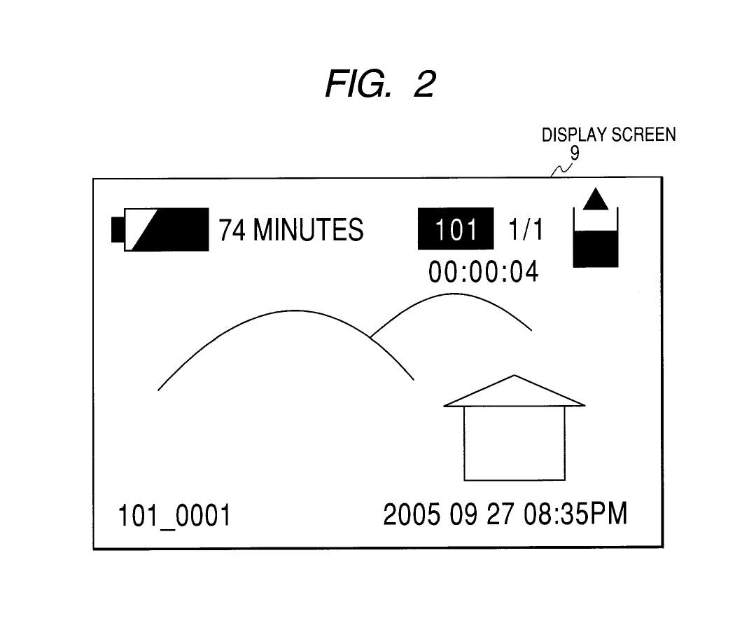

In the video camcorder 1, to prevent reduced visibility due to the on-screen display when a dark subject is imaged and displayed, the control unit 7 controls the image superimposing circuit 6 to lower the brightness level of the on-screen display for information on operational conditions of the video camcorder 1, among information to be notified to the user, in response to decrease in brightness level of the imaging result, as shown in FIG. 2.

In the example shown in FIG. 2, remaining available battery run time is displayed along with a symbol at the upper left corner of the display screen of the display 9. Available capacity of the memory card is displayed as a symbol at the upper right corner. Information on the movie file being imaged is displayed on the center side of this display. The information on the movie file being imaged in this example includes the name of a folder (101) where the recorded movie is saved and the time lapsed from the start of recording (00:00:04). The file name of the movie file being imaged (101_{—}0001) is displayed at the lower left corner and the current date and time (2005 09 27 08:35 PM) is displayed at the lower right corner.

On the other hand, important warnings are displayed by blinking on-screen displays at a fixed brightness level, as in the case of related art. Such important warnings include those indicating that the battery is drained and a recording medium is not loaded.

That is, in the video camcorder 1, the image superimposing circuit 6 changes the brightness level of the on-screen display video signal S2 under the control of the control unit 7 and superimposes the resultant on-screen display video signal S2 on the video signal S1 of the imaging result.

The character/symbol generation circuit 8 generates and outputs an on-screen display video signal S2 under the control of the control unit 7.

The control unit 7 is computation processing means that executes a program stored in a memory (not shown) and executes the program to control operations of the entire video camcorder 1 in response to user operations. In this embodiment, although the program is pre-installed, it may instead be provided via an optical disk, a magnetic disk, a memory card or other recording medium, even through downloading via a network, such as the Internet.

When the user instructs to start imaging, the thus configured control unit 7 acquires an imaging result and displays it on the display 9. Then, when the user instructs to start recording, the control unit 7 switches the operation mode to the recording mode and uses the recording unit 5 to record the video signal S1 outputted from the camera signal processing circuit 4 on the recording medium. When the user further instructs to reproduce the imaging result recorded on the recording medium, the control unit 7 controls the operation of a reproducing unit (not shown) to reproduce the imaging result from the recording medium and displays the reproduced imaging result on the display 9.

During the series of above operations, the control unit 7 monitors the operation of each portion, and based on the monitored results, instructs the character/symbol generation circuit 8 to generate the on-screen display video signal S2. In this way, the video camcorder 1 displays the monitoring image of the imaging result on the display 9 and notifies the user of information on operational and other conditions through the on-screen display on the monitoring image. The control unit 7 thus forms a function block of a controller 10 responsible for the on-screen control.

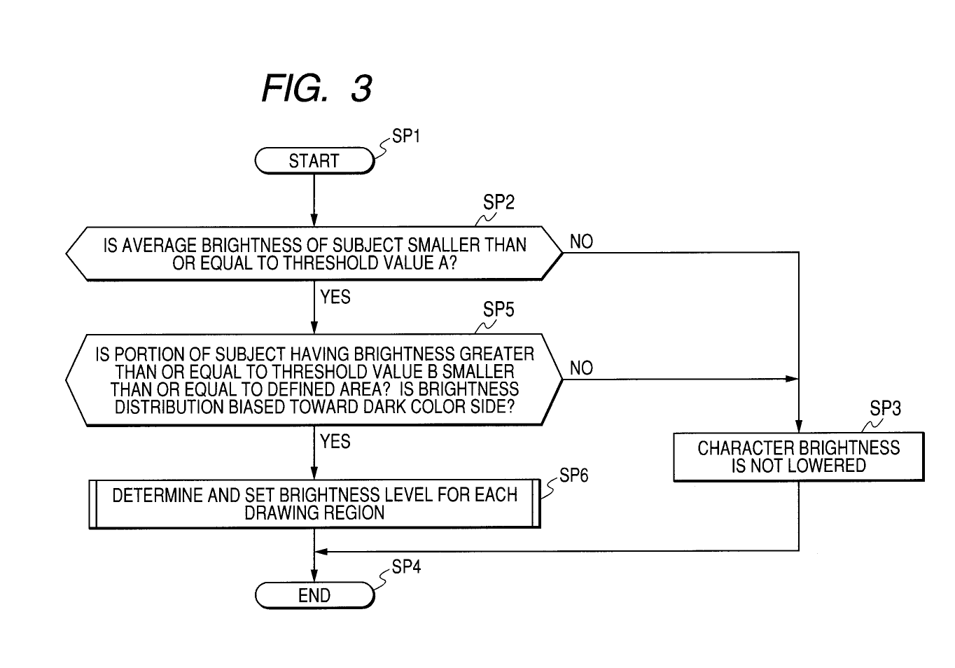

Furthermore, when the monitoring image of the imaging result obtained by the imaging system is displayed, the control unit 7 repeats a process procedure shown in FIG. 3 for each frame to control the brightness level of the on-screen display according to the brightness level of the imaging result. On the other hand, when the video camcorder 1 displays a monitoring image of a reproduced result, the on-screen display is set to the 100[%] brightness level. That is, upon starting this process procedure, the control unit 7 proceeds from step SP1 to step SP2 and calculates an average brightness level of the imaging result for one frame. The control unit 7 then determines whether or not the average one-frame brightness level is lower than or equal to a predetermined threshold A. If the control unit 7 receives a “No” result, the control unit 7 proceeds from step SP2 to step SP3 and sets that frame to keep the current brightness level of the on-screen display. Then, the control unit 7 proceeds to step SP4 and terminates the process procedure.

On the other hand, the control unit 7 receives a “Yes” result in step SP2, it proceeds from step SP2 to step SP5, where the control unit 7 detects the area in one frame to be processed having a brightness level higher than or equal to a predetermined threshold B and determines whether or not this area is smaller than or equal to a fixed area. The control unit 7 also detects the brightness level distribution in that one frame and determines whether or not the distribution is biased toward the black level side. If the control unit 7 receives a “No” result from either of these two determination processes, the control unit 7 proceeds from step SP5 to step SP3 and sets again the on-screen display to keep the current brightness level. The control unit 7 then proceeds to step SP4 and terminates the process procedure.

On the other hand, if the area having a brightness level higher than or equal to the fixed level is smaller than or equal to the fixed value, and the brightness level distribution is biased toward the black level side, then the control unit 7 proceeds from step SP5 to step SP6, where the control unit 7 determines and sets the brightness level for each drawing region. The control unit 7 then proceeds to step SP4 and terminates the process procedure.

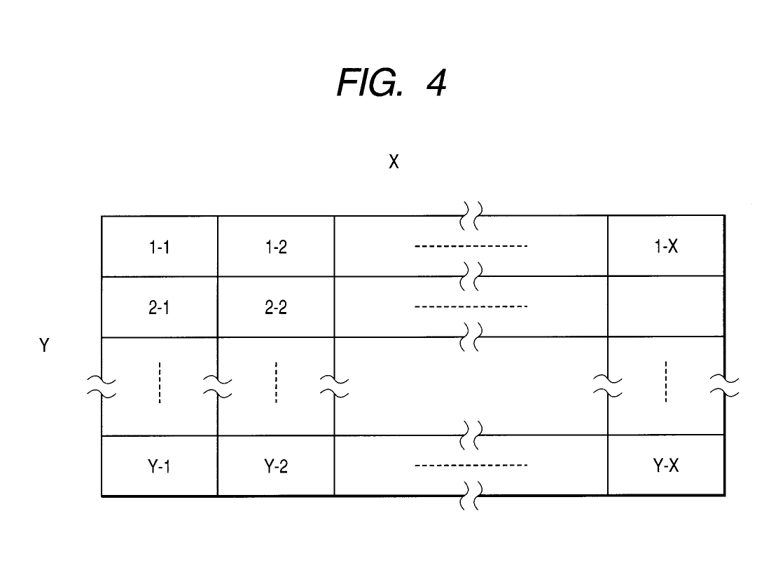

The process of determining and setting the brightness level for each drawing region is a process of determining whether or not to change the brightness level of the on-screen display for each region where on-screen display characters, symbols and the like are displayed and setting the brightness level of the on-screen display accordingly. In this embodiment, as shown in FIG. 4, a monitoring image is divided into a fixed number of blocks in the x and y directions and the on-screen display video signal S2 is evaluated for each of the blocks, so as to detect the region for displaying on-screen display characters, symbols and the like and perform the process of determining and setting the brightness level for each of the drawing regions. The division into blocks is performed such that the effective display region of an imaging result is divided, for example, into 3 by 3 blocks in the horizontal and vertical directions.

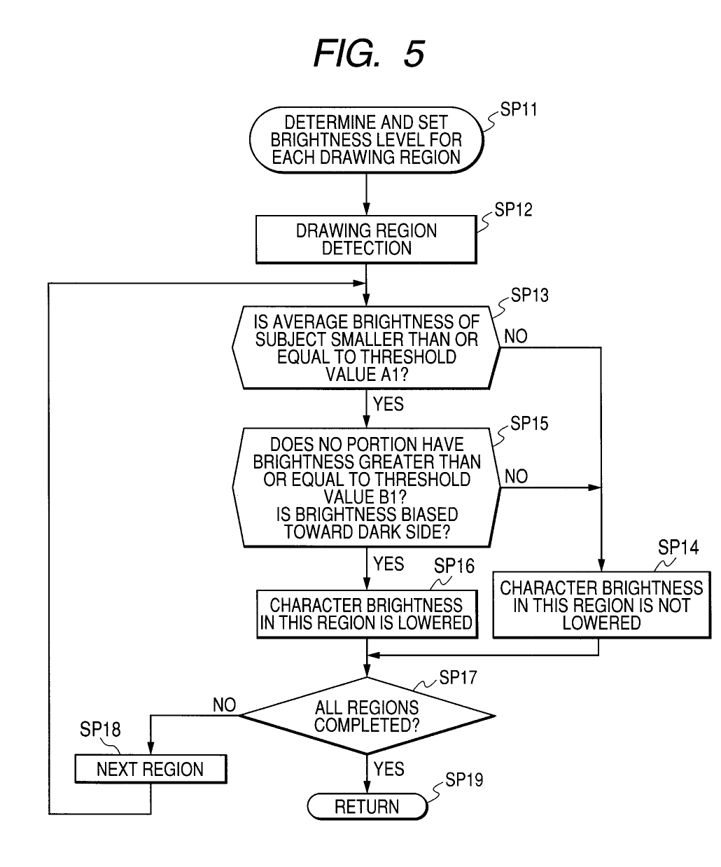

That is, as shown in FIG. 5, upon starting the process of determining and setting the brightness level for each drawing region, the control unit 7 proceeds from step SP11 to step SP12 and detects a region where on-screen display characters, symbols and the like are displayed. The detection of a region where on-screen display characters and symbols are displayed is performed to detect displayed information indicative of the operational conditions described above with reference to FIG. 2.

In the subsequent step SP13, the control unit 7 calculates the average brightness level of one frame for one of the detected regions. The control unit 7 then determines whether or not the calculated average brightness level is lower than or equal to a predetermined threshold A1. If the control unit 7 receives a “No” result, the control unit 7 proceeds from step SP13 to step SP14 and sets that region to keep the current brightness level of the on-screen display. The control unit 7 then proceeds to step SP17.

On the other hand, if the control unit 7 receives a “Yes” result in step SP13, the control unit 7 proceeds from step SP13 to step SP15 and determines, for this region, whether or not the area having a brightness level higher than or equal to a fixed value is smaller than or equal to a fixed value and whether or not the brightness level distribution is biased toward the black level side. If the control unit 7 receives a “No” result, the control unit 7 proceeds from step SP15 to step SP14 and sets again that region to keep the current brightness level of the on-screen display. The control unit 7 then proceeds to step SP17.

On the other hand, if the control unit 7 receives a “Yes” result in step SP15, the control unit 7 proceeds from step SP15 to step SP16 and sets that region to lower the brightness level of the on-screen display.

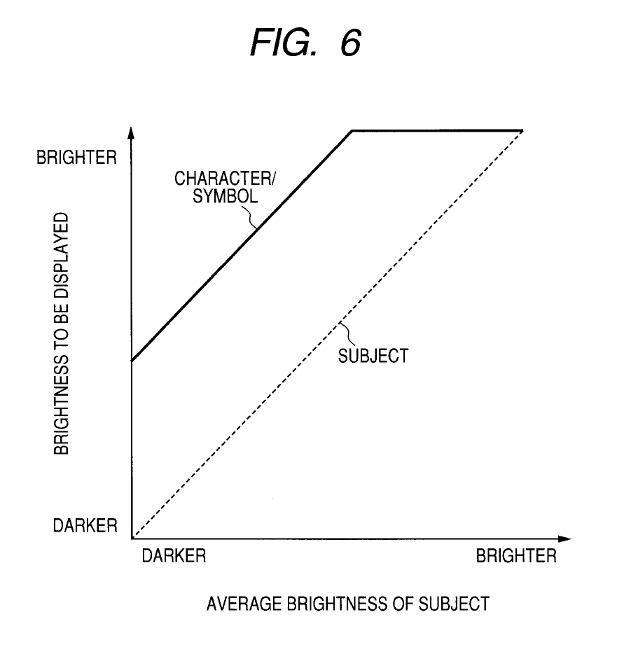

The brightness level is lowered such that the brightness level of the on-screen display is higher than the average brightness level of a subject by a fixed signal level, as shown in FIG. 6. In this way, when the average brightness level of this region is higher than or equal to the fixed value, the control unit 7 displays on-screen display characters and symbols at the 100[%] brightness level, while when the brightness level of this region decreases by at least a fixed value, the control unit 7 lowers the brightness level of the on-screen display according to the decrease in brightness level of this region. When the brightness level of the on-screen display is lowered, a brightness level obtained by averaging average brightness levels of a plurality of successive frames of each region of interest is used as the average brightness level used in the process of step SP16, allowing the brightness level of the on-screen display to be gradually lowered. In this case, the time constant is set to about one second. On the other hand, when the on-screen display is controlled such that its brightness level is increased, the time constant is set to zero or a much smaller value.

After the brightness level of this region is thus set, the control unit 7 proceeds to step SP17.

In step SP17, the control unit 7 determines whether or not the processes have been completed for all regions detected in step SP12. If the control unit 7 receives a “No” result, the control unit 7 proceeds from step SP17 to step SP18 and switches to the next region to be processed. The control unit 7 then returns to step SP13. On the other hand, when the processes have been completed for all regions detected in step SP12, the control unit 7 receives a “Yes” result in step SP17. The control unit 7 then proceeds from step SP17 to step SP19 and terminates the process procedure.

As described above, the control unit 7 forms a function block of a drawing region detection circuit 11 responsible for the process in step SP12, as well as function blocks of an average value detection circuit 12, a peak value detection circuit 13 and a brightness distribution detection circuit 14 responsible for average value detection, detection of the area having a brightness level higher than or equal to a fixed value and brightness distribution detection, respectively, used for the processes shown in FIGS. 3 and 5. The control unit 7 also forms a function block of a brightness level setting circuit 15 that sets the brightness level of the on-screen display based on detection results from the drawing region detection circuit 11, the average value detection circuit 12, the peak value detection circuit 13 and the brightness distribution detection circuit 14.

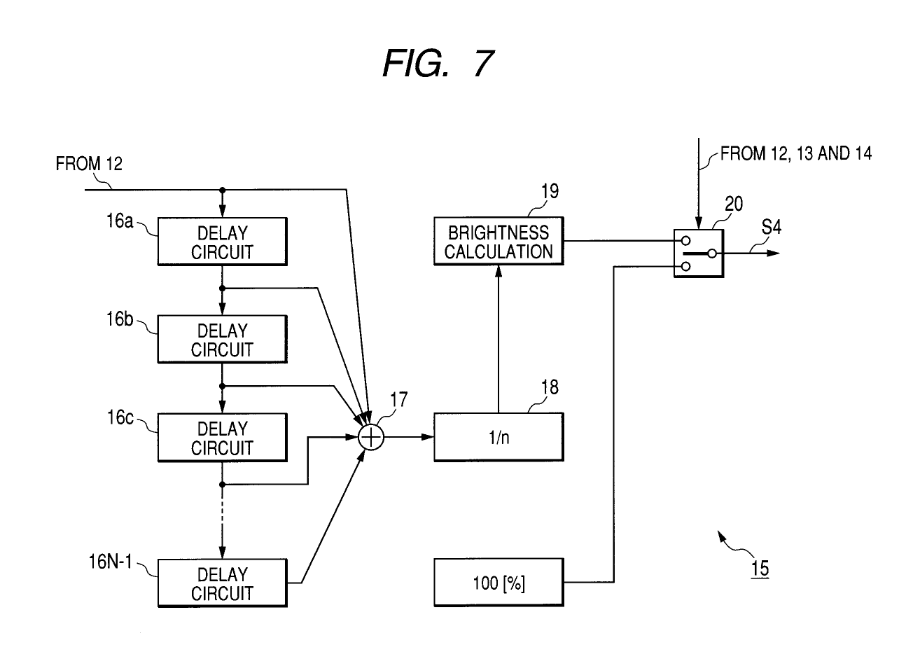

As shown in FIG. 7, in the function block of the brightness level setting circuit 15, the control unit 7 further forms function blocks of delay circuits 16a to 16N−1, an adder circuit 17 and a divider circuit 18, where the delay circuit sequentially delays the average brightness level of each region detected by the average value detection circuit 12 by one frame period for averaging. The control unit 7 also forms a function block of a brightness calculator 19 that uses the thus obtained average brightness level of a plurality of frames to calculate the brightness level of the on-screen display, as well as a function block of a selection circuit 20 that switches between the instruction to display the on-screen display at a brightness level calculated by the brightness calculator 19 and the instruction to display the on-screen display at the 100[%] brightness level and outputs the selected instruction based on detection results from the average value detection circuit 12, the peak value detection circuit 13 and the brightness distribution detection circuit 14.

### (2) Operation of the Embodiment

In the video camcorder 1 thus configured (FIG. 1), an imaging result acquired from the imaging element 3 is processed in the camera signal processing circuit 4 to generate a video signal S1, which is displayed on the display 9 to provide a monitoring image. When the user subsequently instructs to record the imaging result, the video signal S1 outputted from the camera signal processing circuit 4 undergoes data compression performed in the recording unit 5 and then is recorded on a recording medium. Upon a user's instruction, the thus recorded imaging result is reproduced and displayed on the display 9.

When the video camcorder 1 performs such a series of processes, the control unit 7 monitors the operation of each portion. The control unit 7 controls the character/symbol generation circuit 8 to generate an on-screen display video signal S2 and combines the on-screen display video signal S2 with the monitoring video signal S1 in the image superimposing circuit 6. In the video camcorder 1, operational conditions and various malfunctions of the video camcorder 1 can be thus monitored through the on-screen display on the monitoring image that shows imaging results and reproduced results.

A dark subject may be imaged by the video camcorder 1 and the imaging result of the dark subject is monitored on the display 9. In this case, when on-screen display character, symbols and the like are displayed at 100[%] brightness level, as in related art, the user may not be able to check details of the dark subject. Furthermore, when imaging in a dark environment, the user may be annoyed by glare from the on-screen display.

Among the information provided to the user in the form of such an on-screen display, information on operational conditions of the apparatus (FIG. 2) is less urgent compared to the on-screen display indicative of apparatus malfunctions. In other words, the information on operational conditions of the apparatus is what the user checks as necessary and may not at all be required by some users. When a dark subject is being imaged, such information on a monitoring image is nevertheless displayed at a sufficiently high brightness level relative to the background.

While such information on operational conditions is thus displayed with sufficient visibility in related art, the information will be much more visible to the user when a dark subject is imaged.

Therefore, when an imaging result is obtained and its monitoring image is displayed, the video camcorder 1 prevents reduced visibility due to an on-screen display when a dark subject is imaged and displayed by lowering the brightness level of the on-screen display in response to decrease in brightness level of the monitoring image. Furthermore, in this case, when the brightness level of the imaging result is lower than or equal to a fixed value, the video camcorder 1 controls the brightness level of the on-screen display in this way to prevent reduced visibility due to the on-screen display.

That is, in the video camcorder 1, the control unit 7 calculates and detects the average brightness level of the imaging result on a frame basis. Then, the image superimposing circuit 6 controls the brightness level of the on-screen display based on the average brightness level. In this way, when the brightness level of the imaging result is lower than or equal to a fixed value, the video camcorder 1 controls the brightness level of the on-screen display to prevent reduced visibility due to the on-screen display.

More specifically, when the average brightness level of one frame is higher than or equal to the fixed value, the video camcorder 1 is likely imaging a sufficiently bright subject. In this case, the on-screen display is less visible by the amount of higher background compared to the case when a dark subject is imaged. In this case, the on-screen display is set to the 100[%] brightness level to prevent reduced visibility of the on-screen display (from step SP2 to step SP3 in FIG. 3).

On the other hand, when the average brightness level of one frame is lower than the fixed value but the imaging result has large ups and downs in brightness, a so-called high dynamics, it can be said that the area with an imaged subject dark enough to be less visible due to the on-screen display is small relative to the whole imaging result. In this case, again, the on-screen display is set to the 100[%] brightness level, so that there will be a relatively large area whose brightness level does not greatly differ from that of the background. When part of the imaging result has a lower brightness level, it can also be said that the area with an imaged subject dark enough to be less visible is small relative to the whole imaging result. Thus, even if the average brightness level of one frame is lower than the fixed value, but the region having a brightness level higher than or equal to a fixed value is greater than or equal to a fixed area, or the brightness distribution is not biased toward the black level side, then the video camcorder 1 sets the on-screen display to the 100[%] brightness level to prevent reduced visibility of the on-screen display (from step SP5 to step SP3 in FIG. 3).

On the other hand, if the average brightness level of one frame is lower than the fixed value, and the region having a brightness level higher than or equal to the fixed value is smaller than the fixed area, and the brightness distribution is biased toward the black level side, then there is likely a region where an imaged dark subject occupies a substantial area.

However, even in such a case, when sunset scenery is imaged, for example, the sky will be imaged as a bright portion. In such a case, part of the imaging result may have a region having a sufficiently high brightness level. In this case, if the brightness level of the on-screen display is lowered in such a region having a sufficiently high brightness level, the on-screen display will be less visible in that region.

As described above, in the video camcorder 1, if the average brightness level of one frame is lower than the fixed value, and the region having a brightness level higher than or equal to the fixed value is smaller than or equal to the fixed area, and the brightness distribution is biased toward the black level side, then the imaging result is divided into a plurality of regions to detect a region where on-screen characters, symbols and the like are displayed (FIG. 4 and step SP12 in FIG. 5). Then, each region where these characters, symbols and the like are displayed is evaluated whether or not it has an imaged dark subject, and from the evaluation result, the brightness level of the on-screen display is controlled accordingly.

That is, in the video camcorder 1, if the average brightness level of each region is higher than a predetermined value, that region does not include an imaged dark subject and the on-screen display in that region will be set to the 100[%] brightness level (from step SP13 to step SP14 in FIG. 5).

On the other hand, if the average brightness level is lower than or equal to this predetermined value and the dynamics is high, it can be said that part of the imaging result has a small portion having a lower brightness level and the area with an imaged subject dark enough to be less visible due to the on-screen display is small relative to the whole imaging result. In this case, again, the on-screen display is set to the 100[%] brightness level, so that there will be a relatively large area whose brightness level does not greatly differ from that of the background. When part of the imaging result has a lower brightness level, it can also be said that the area with an imaged subject dark enough to be less visible is small relative to the whole imaging result.

As described above, in the video camcorder 1, if the average brightness level is lower than or equal to this predetermined value, and the region having a brightness level higher than or equal to the fixed value is greater than or equal to the fixed area, and the brightness distribution is not biased toward the black level side, then the on-screen display is set to the 100[%] brightness level to prevent reduced visibility of the on-screen display (from step SP15 to step SP14 in FIG. 5).

On the other hand, if the average brightness level is lower than or equal to this predetermined value, and the region having a brightness level higher than or equal to the fixed value is smaller than the fixed area, and the brightness distribution is biased toward the black level side, then it can be said that most of the region is occupied with an imaged dark subject. In this case, the brightness level of the on-screen display is set according to the average brightness level of that region. In this way, the video camcorder 1 prevents reduced visibility of the dark subject that is present in that region due to the on-screen display by lowering the brightness level of the on-screen display in that region in response to decrease in brightness level of that region in the monitoring image (step SP15 to step SP16 in FIG. 5, and FIG. 6).

When the brightness level of the on-screen display is thus lowered, the video camcorder 1 detects the average brightness level of this region for a plurality of successive frames and sets the brightness level of the on-screen display based on this average brightness level. In this way, the video camcorder 1 prevents an abrupt change in brightness level of the on-screen display, ensuring an easy-to-see display screen of the display 9 (FIG. 7).

On the other hand, when the brightness level is increased, a time constant shorter than that used when the brightness level is lowered is used to increase the brightness level such that the increase follows the change in average brightness level of each region.

Since the process used when the brightness level of the on-screen display is lowered is a process of reducing the increased difference in brightness level between the on-screen display and the background, sufficient visibility of the on-screen display can be ensured even when its brightness level is slowly lowered using a long time constant. However, the process used when the brightness level of the on-screen display is increased is a process of increasing the decreased difference in brightness level between the on-screen display and the background, so that the on-screen display will be less visible when its brightness level is slowly increased using a long time constant.

As described above, in the video camcorder 1, the brightness level is slowly lowered using a long time constant, while the brightness level is quickly increased using a short time constant, thereby preventing reduced visibility of the on-screen display.

In this way, the video camcorder 1 effectively prevents reduced visibility of the on-screen display, while preventing reduced visibility due to the on-screen display when a dark subject is imaged and displayed.

On the other hand, for important warnings different from such information on operational conditions, such as those indicating that the battery is drained and a recording medium is not loaded, those warnings are displayed by blinking on-screen displays at the 100[%] brightness level. In this way, when such important information is notified, the first priority is given to conveying on-screen display information while the visibility of a dark subject is ignored, providing more user-friendliness.

### (3) Advantages of the Embodiment

The configuration described above can prevent reduced visibility due to an on-screen display when a dark subject is imaged and displayed by lowering the brightness level of the on-screen display in response to decrease in brightness level of a monitoring image.

Specifically, the average brightness level of one frame and the average brightness level of a plurality of frames are detected, and the brightness level of the on-screen display is set according to the average brightness level of the plurality of frames when the average brightness level of one frame becomes lower than or equal to a fixed value, thereby preventing an abrupt change in brightness level of the on-screen display to provide an easy-to-see monitoring image.

Also, the average brightness level and the area having a brightness level higher than or equal to a fixed value are detected, and the brightness level of the on-screen display is set according to the average brightness level when the average brightness level is lower than or equal to a fixed value and the area is smaller than or equal to a fixed value, thereby preventing reduced visibility of the on-screen display as well as reduced visibility of the imaging result when a dark subject is imaged and displayed.

Furthermore, the average brightness level and the brightness distribution are detected, and the brightness level of the on-screen display is set according to the average brightness level when the average brightness level is lower than or equal to a fixed value and the brightness distribution is biased toward the black level side, thereby also preventing reduced visibility of the on-screen display as well as reduced visibility of the imaging result when a dark subject is imaged and displayed.

Moreover, controlling the brightness level of the on-screen display for each region where on-screen information is displayed also prevents reduced visibility of the on-screen display as well as reduced visibility of the imaging result when a dark subject is imaged and displayed.

Displaying information that thus involves controlling the brightness level of the on-screen display is to display information that notifies operational conditions of the apparatus to the user. Therefore, when important information is notified, the first priority is given to conveying on-screen display information while reduced visibility of a dark subject is ignored, providing more user-friendliness.

### Second Embodiment

In the above embodiment, although the description has been given to the case where after it is selected to control the brightness level of the on-screen display based on the average brightness level of one frame and the dynamics, it is finally determined to control the brightness level of the on-screen display based on the average brightness level and the dynamics for each on-screen display region so as to control the brightness level accordingly, the invention is not limited thereto. For example, when practically sufficient characteristics can be ensured, it may be selected to control the brightness level of the on-screen display simply based on the average brightness level of one frame and the dynamics so as to control the brightness level accordingly, or it may be determined to control the brightness level of the on-screen display simply based on the average brightness level and the dynamics for each on-screen display region so as to control the brightness level accordingly.

In the above embodiment, although the description has been given to the case where the brightness level of the on-screen display is controlled by excluding a frame and region having an average brightness level higher than or equal to a predetermined value, a frame and region having an area greater than or equal to a fixed value whose brightness level is higher than or equal to a fixed value, and a frame and region whose brightness distribution is not biased toward the black level side, the invention is not limited thereto. For example, when practically sufficient characteristics can be ensured, the requirements for the above exclusion may be relaxed to simplify the process.

In the above embodiment, although the description has been given to the case where the brightness level of the on-screen display is controlled for each region that is finally involved in on-screen display, the invention is not limited thereto. For example, when practically sufficient characteristics can be ensured, the brightness level of the whole screen with on-screen displays may be controlled altogether based on the average brightness level of the whole screen. Furthermore, for example, an imaging result may be displayed in a window and characters, symbols and the like may be displayed around the window. Even in such a case, the brightness levels of these on-screen display characters, symbols and the like can be controlled to prevent reduced visibility of a dark subject. In this case, the brightness level of the on-screen display will be controlled based on the brightness level of the imaging result in a region close to the region where the characters and symbols are displayed.

In the above embodiment, although the description has been given to the case where when a reproduced result is displayed, the brightness level of the on-screen display is set to a fixed brightness level of 100[%], the invention is not limited thereto. For example, the brightness level of the on-screen display may also be controlled when a reproduced result is displayed.

In the above embodiment, although the description has been given to the case where the invention is applied to a video camcorder, the invention is not limited thereto. For example, the invention may be applied to a wide variety of imaging apparatuses, such as a digital still camera, a mobile phone with an imaging capability and a PDA (Personal Digital Assistant) with an imaging capability. Some of mobile phones with an imaging capability have a display screen formed of a display region for a monitoring image and an on-screen display peripheral region.

The invention can be applied to, for example, a video camcorder.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus that displays a monitoring image of an imaging result acquired by an imaging unit on a monitor and also displays information on the apparatus on the monitor in the form of an on-screen display on the monitoring image, the apparatus comprising:
a brightness level detection unit that detects the brightness level of the imaging result and outputs the brightness level detection result; and
a display control unit that controls the brightness level of the on-screen display according to the brightness level detection result to lower the brightness level of the displayed information on the apparatus in response to decrease in brightness level of the imaging result.

2. The imaging apparatus according to claim 1, wherein the brightness level detection unit outputs the brightness level detection result including the average brightness level of one frame and the average brightness level of a plurality of frames, and
the display control unit sets the brightness level of the on-screen display according to the average brightness level of the plurality of frames when the average brightness level of the one frame becomes lower than or equal to a fixed value.

3. The imaging apparatus according to claim 1, wherein the brightness level detection unit outputs the brightness level detection result including the average brightness level and the area having a brightness level higher than or equal to a fixed value, and
the display control unit sets the brightness level of the on-screen display according to the average brightness level when the average brightness level is lower than or equal to a fixed value and the area is smaller than or equal to a fixed value.

4. The imaging apparatus according to claim 1, wherein the brightness level detection unit outputs the brightness level detection result including the average brightness level and a brightness distribution, and
the display control unit sets the brightness level of the on-screen display according to the average brightness level when the average brightness level is lower than or equal to a fixed value and the brightness distribution is biased toward the black level side.

5. The imaging apparatus according to claim 1, wherein the brightness level detection unit outputs the brightness level detection result for each region where on-screen information is displayed, and
the display control unit controls the brightness level of the on-screen display for each of the regions.

6. The imaging apparatus according to claim 1, wherein the information on the apparatus is information on operational conditions of the apparatus.

7. The imaging apparatus according to claim 1, further comprising:
a recording unit that records the imaging result; and
a reproducing unit that reproduces the imaging result recorded on the recording unit,
wherein an user instruction switches the operation mode to a reproducing mode to replace the imaging result provided from the imaging unit with a reproduced result provided from the reproducing unit and display the reproduced result on the monitor, and
in the reproducing mode, the brightness level detection unit detects the brightness level of the reproduced result provided from the reproducing unit instead of the imaging result provided from the imaging unit and outputs the brightness level detection result.

8. A displaying method for an imaging apparatus that displays a monitoring image of an imaging result acquired by an imaging unit on a monitor and also displays information on the apparatus on the monitor in the form of an on-screen display on the monitoring image, the method comprising the steps of:
detecting the brightness level of the imaging result and outputting the brightness level detection result; and
controlling the on-screen display according to the brightness level detection result to lower the brightness level of the displayed information on the apparatus in response to decrease in brightness level of the imaging result.
